(19) United States
(12) Patent Application Publication
(10) Pub. No.: US 2021/0276458 A1
(43) Pub. Date: Sep. 9, 2021

(54) VEHICLE SEAT DEVICE AND AIR PRESSURE CONTROL METHOD FOR VEHICLE SEAT

(71) Applicants: AISIN SEIKI KABUSHIKI KAISHA, Kariya-shi, Aichi-ken (JP); TOYOTA JIDOSHA KABUSHIKI KAISHA, Toyota-shi, Aichi-ken (JP)

(72) Inventors: Yuki FUJII, Obu-shi (JP); Akiyoshi SHIBATA, Nagoya-shi (JP); Hiroyuki ODA, Hamamatsu-shi (JP); Shunsuke HAYAKAWA, Obu-shi (JP); Shunsuke TANAKA, Nisshin-shi (JP); Shinichiro KOMAKI, Toyota-shi (JP); Kenji HASHIMOTO, Nisshin-shi (JP)

(73) Assignees: Aisin Seiki Kabushiki Kaisha, Karya-shi, Aichi-ken (JP); Toyota Jidosha Kabushiki Kaisha, Toyota-shi, Aichi-ken (JP)

(21) Appl. No.: 16/338,862

(22) PCT Filed: Sep. 28, 2017
(86) PCT No.: PCT/JP2017/035314

§ 371 Date: Apr. 2, 2019

(30) Foreign Application Priority Data
Oct. 6, 2016 (JP) 2016-198144

(51) Int. Cl. B60N 2/02; B60N 2/90

(52) U.S. Cl. CPC B60N 2/0244; B60N 2002/026; B60N 2/976; B60N 2/914

(57) ABSTRACT

A controller, which serves as a pressure-feeding control portion, drives an air pump to pressure-feed air to massage airbags located in a seat. In addition, the controller, which serves as an inflation-deflation control portion, performs massage control that inflates and deflates the airbags while keeping the air pump driven by controlling the operation of intake-discharge valves in second flow passage (branch lines), which connects the air pump to the airbags. Furthermore, the controller, which serves as a decompression control portion, opens a discharge valve, which is located upstream of the intake-discharge valves, in a state in which the airbags are deflated during the massage control.

### TECHNICAL FIELD

The present invention relates to a vehicle seat device and a method for controlling air pressure of a vehicle seat.

### BACKGROUND ART

Patent Document 1 describes a vehicle seat device that is capable of changing the support shape of the seat by inflating and deflating airbags (bladders) arranged inside the seat. Patent Document 2 describes a seat device that gives massage to the occupant on the seat by inflating and deflating airbags to press the seat surface from the inside.

Such seat devices are typically configured to pressure-feed air to inflate airbags using an air pump, which is driven by a motor. The air pump of the seat device of Patent Document 2 is arranged in the trunk compartment at the rear of the vehicle so as to reduce the effects of vibration and noise created when the air pump is actuated.

The conventional structure requires installation space in the trunk compartment where the air pump can operate stably. This lengthens the air flow passage connecting the air pump to the airbags and therefore complicates the routing of the tubes forming the flow passage. In addition, the tubes require protection and measures against condensation.

### PRIOR ART DOCUMENTS

### Patent Documents

Patent Document 1: Japanese Laid-Open Patent Publication No. 2010-235021 Patent Document 2: Japanese Laid-Open Patent Publication No. 2006-198071

### SUMMARY OF THE INVENTION

### Problems that the Invention is to Solve

It is an objective of the present disclosure to provide a vehicle seat device and a method for controlling air pressure of a vehicle seat that achieve improved quietness.

### Means for Solving the Problems

In accordance with a first aspect of the present invention, a vehicle seat device is provided that includes an air pump, a pressure-feeding control portion configured to pressure-feed air to an airbag located in a seat by driving the air pump, an intake-discharge valve located in a flow passage connecting the air pump to the airbag, an inflation-deflation control portion configured to inflate and deflate the airbag by controlling operation of the intake-discharge valve while keeping the air pump driven, a discharge valve located upstream of the intake-discharge valve in the flow passage, and a decompression control portion configured to open the discharge valve in a state in which the airbag is deflated.

In accordance with a second aspect of the present invention, a method for controlling air pressure of a vehicle seat is provided. The method includes: pressure-feeding air to an airbag located in a seat by driving an air pump; inflating and deflating the airbag while keeping the air pump driven by controlling operation of an intake-discharge valve located in a flow passage connecting the air pump to the airbag; and opening a discharge valve located upstream of the intake-discharge valve in the flow passage in a state in which the airbag is deflated.

### BRIEF DESCRIPTION OF THE DRAWINGS

FIG. 1 is a perspective view showing a vehicle seat with seat-support airbags.

FIG. 2 is a perspective view showing a vehicle seat with massage airbags.

FIG. 3 is a schematic view showing the structure of a seat device.

FIGS. 4A to 4G are diagrams illustrating an example of massage control.

FIG. 5 is a timing chart showing an operation state of an air pump and intake-discharge valves in massage control and the opening timing of a discharge valve.

FIG. 6 is a flowchart showing another example of decompression control performed during massage control.

### MODES FOR CARRYING OUT THE INVENTION

Referring to the drawings, a pneumatic seat device having a seat support function and a massage function and air pressure control of the seat device according to an embodiment will now be described.

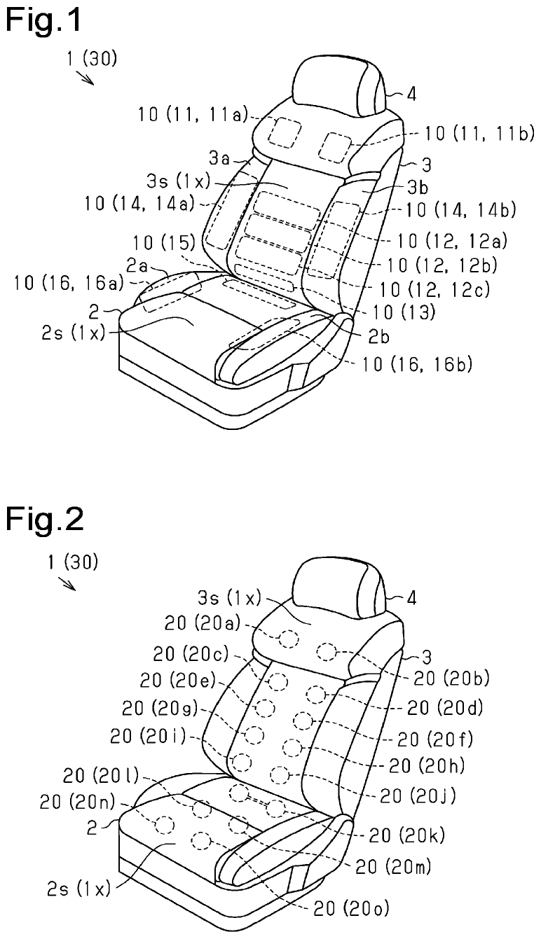

As shown in FIGS. 1 and 2, a vehicle seat 1 includes a seat cushion 2 and a seat back 3, which is at the rear end of the seat cushion 2. A headrest 4 is arranged on the upper end of the seat back 3.

The seat back 3 includes side sections 3a and 3b, which protrude frontward. The seat cushion 2 includes side sections 2a and 2b, which protrude upward. The seat 1 thus allows an occupant to be seated with a good posture, and also maintains the posture of the occupant.

The seat 1 includes airbags 10 (11 to 16), which is inflated and deflated inside the seat cushion 2 and the seat back 3 so as to change the surface shape of the seat 1. In addition, the seat 1 includes airbags 20 (20a to 20o), which are inflated and deflated inside the seat cushion 2 and the seat back 3 so as to press the seat surface 1x from the inside. The seat device 1 is thus capable of changing the support shape of the seat 1 and giving massage (refreshing) to the occupant who is seated on the seat 1.

Specifically, seat-support airbags 11 (11a and 11b), 12 (12a to 12c) and 13 are separately arranged inside the seat back 3 at positions corresponding to the shoulder section, the lumbar section, and the bottom section (the back and pelvis section) of the backrest surface 3s. In addition, seat-support airbags 14 (14a and 14b) are separately arranged at the positions corresponding to the two side sections 3a and 3b of the seat back 3. Further, the seat cushion 2 includes seat-support airbags 15 and 16 (16a and 16b) separately arranged inside the rear end (the pelvis cushion) of the seating surface 2s and the two side sections 2a and 2b.

Massage airbags 20 (20a to 20j) (refreshing) are arranged inside the seat back 3. The airbags 20a to 20j are arranged along the backrest surface 3s. The seat cushion 2 also includes massage airbags 20 (20k to 20o). The airbags 20k to 20o are arranged along the seating surface 2s.

Specifically, the airbags 20a to 20j are arranged in the up-down direction along the right section and the left section of the backrest surface 3s. The airbags 203 to 20o are arranged in the front-rear direction along the right section and the left section of the seating surface 2s. The airbag 20k, which is located at the rear-most end of the seating surface 2s, includes a pair of a left cell and a right cell, which is inflated and deflated integrally.

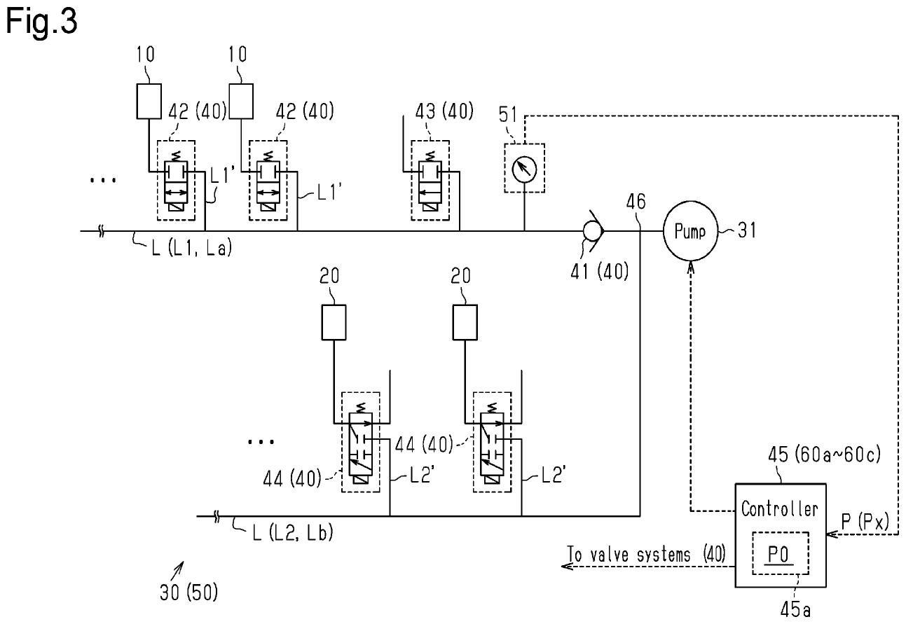

As shown in FIG. 3, the seat device 30 includes an air pump 31 for pressure-feeding air to the airbags 10 and 20. The seat device 30 also includes a flow passage L, which connects the air pump 31 to the airbags 10 and 20, and valve systems 40 (41 to 44) located in the flow passage L. The operation of the air pump 31 and the valve systems 40 are controlled by a controller 45.

The controller 45 may include a microcomputer and/or dedicated hardware (an application-specific integrated circuit (ASIC)) that performs at least part of various processes. That is, the controller 45 may be configured as circuitry that includes: 1) at least one processor (microcomputer) that operates according to a computer program (software); 2) at least one dedicated hardware circuit, such as an ASIC; or 3) a combination of 1) and 2). The air pump 31 and the valve systems 40 form an intake-discharge device 50, which includes the flow passage L. The flow passage L includes a first flow passage L1, which connects the air pump 31 to the seat-support seat-support airbags 10, and a second flow passage L2, which connects the air pump 31 to the massage airbags 20. The second flow passage L2 branches off from the first flow passage L1. When the air pump 31 is on the upstream side, a check valve 41 is located downstream of the branching point 46 where the second flow passage L2 branches off from the first flow passage L1. The seat-support seat-support airbags 10 communicate with the first flow passage L1 on the downstream side of the check valve 41.

Specifically, the seat-support seat-support airbags 10 are connected to branch lines L1′, which branch off from the main line La of the first flow passage L1. That is, as viewed from each branch line L1′, the main line La of the first flow passage L1 is upstream of the branch line L1′ regardless of its position. Each branch line L1′ includes an intake valve 42. A discharge valve 43 is located downstream of the check valve 41 in the first flow passage L1.

In a similar manner, the massage airbags 20 are connected to branch lines L2′, which branch off from the main line Lb of the second flow passage L2. That is, as viewed from each branch line L2′, the main line Lb of the second flow passage L2 is upstream of the branch line L2′ regardless of its position. Each branch line L2′ includes an intake-discharge valve 44. The controller 45 cooperates with the air pump 31 to control the operation of the intake valves 42 and the discharge valve 43 in the first flow passage L1 and the intake-discharge valves 44 in the second flow passage L2. Inlet of air, which charges air into the airbags 10 and 20,-discharge of air, which releases air from the airbags 10 and 20, are thus performed.

A pressure sensor 51 is located downstream of the check valve 41 in the first flow passage L1. Based on output signals from the pressure sensor 51, the controller 45 detects the inner pressure P of the seat-support airbags 10, which are connected to the first flow passage L1.

Specifically, to detect the inner pressure P of an airbag 10, the controller 45 closes the discharge valve 43 in the first flow passage L1. In this state, the controller 45 opens the intake valve 42 in the branch line L1′ that communicates with the airbag 10 of which the inner pressure is to be detected. Consequently, the inner pressure P of the airbag 10 to be detected becomes equal to the inner pressure Px of the first flow passage L1 where the pressure sensor 51 is located. The inner pressure detection using the pressure sensor 51 is performed while the intake valve 42 is opened for a fixed period of time. The controller 45 calculates the average of the output signals that are input from the pressure sensor 51 during this period. This limits the effects of the disturbance resulting from the traveling of the vehicle, enabling accurate detection of the inner pressure P of the airbag 10.

The controller 45 stores in a storage region 45a the target values of inner pressure P (inner pressure target values P0) of the seat-support airbags 10. When the occupant sets the optimum support shape using the operation switch (not shown) arranged on the seat 1, the inner pressure target values P0 of the airbags 10 are updated. The controller 45 controls the operation of the air pump 31, the intake valves 42, and the discharge valve 43 such that the detected inner pressure P of each airbag 10 becomes equal to its inner pressure target value P0.

To pressure-feed air to a seat-support airbag 10, the controller 45 opens the intake valve 42 in the branch line L1′ communicating with the airbag 10 and closes the discharge valve 43 in the first flow passage L1. In this state, the controller 45 drives the air pump 31. To release air from the airbag 10, the controller 45 opens the intake valve 42 and the discharge valve 43 with the air pump 31 deactivated.

The intake-discharge valves 44 in the branch lines L2′ of the second flow passage L2 function as three-way valves. That is, each intake-discharge valve 44 is switchable between the first operation state, which permits air to flow into the massage airbag massage airbag 20 from the upstream side of the intake-discharge valve 44, and the second operation state, which blocks air from flowing between the airbag 20 and the second flow passage L2. In addition, each intake-discharge valve 44 is also switchable to the third operation state, which permits the air in the airbag 20 to be released to the outside, while blocking air from flowing between the second flow passage L2 and the airbag 20. The controller 45 inflates and deflates the massage airbags 20 with a predetermined operation pattern by controlling the operation of the intake-discharge valves 44 while keeping the air pump 31 driven.

Specifically, the controller 45 identifies an airbag 20 that is at inflation timing, in other words, an airbag 20 that is brought into an inflated state, and switches the intake-discharge valve 44 in the branch line L2′ of the second flow passage L2 that communicates with this airbag 20 to the first operation state. Consequently, the air pressure-fed from the air pump 31 flows into the airbag 20 through the intake-discharge valve 44 and the branch line L2′ of the second flow passage L2, thereby inflating the airbag 20.

Further, the controller 45 identifies an airbag 20 that is at deflation timing, in other words, an airbag 20 that is brought into a deflated state, and switches the intake-discharge valve 44 corresponding to the target airbag 20 to the third operation state, while keeping the air pump 31 driven. At this time, the intake-discharge valve 44 is closed relative to the second flow passage L2 and opened relative to the outside space. This allows the air in the airbag 20 to be released to the outside without flowing to the upstream side of the intake-discharge valve 44. The airbag 20 is thus deflated while the air pump 31 remains driven.

The controller 45 sequentially changes airbags 20 to be inflated based on the predetermined operation pattern of the massage control. Specifically, the controller 45 alternately performs an inflation pattern (X), which inflates at least one of the massage airbags 20, and an all-deflation pattern (Z), which deflates all of the airbags 20. In addition, the seat device 30 sequentially moves the position where the seat surface 1x is pressed by massage airbags 20 from the inside.

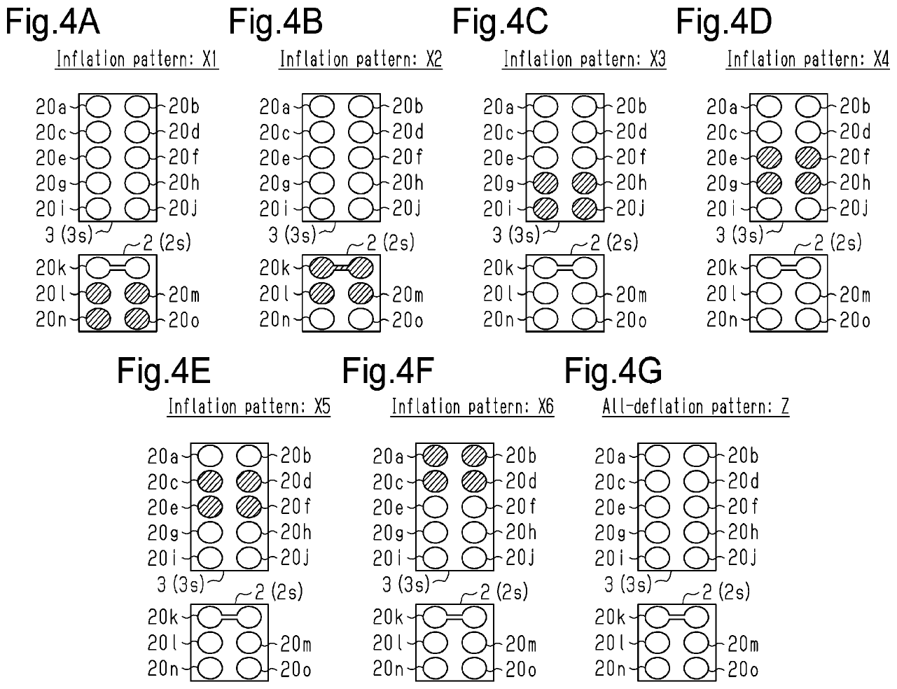

FIGS. 4A to 4G show the state in which the positions pressed by the airbags 20 are changed sequentially from the front to the rear of the seat cushion 2 and from the lower side to the upper side of the seat back 3 (from the lower side to the upper side as viewed in FIGS. 4A to 4G). In this state, the controller 45 sequentially switches between the first to sixth inflation patterns X1 to X6 as follows.

As shown in FIG. 4A, the first inflation pattern X1 inflates the airbags 20l to 20o in the two front rows of the seat cushion 2. As shown in FIG. 4B, the second inflation pattern X2 inflates the airbags 20k to 20m in the two rear rows of the seat cushion 2. As shown in FIG. 4C, the third inflation pattern X3 inflates the airbags 20g to 20j in the two lower rows of the seat back 3. As shown in FIG. 4D, the fourth inflation pattern X4 inflates the airbags 20e to 20h in the two rows of the middle row and the row below the middle row of the seat back 3. As shown in FIG. 4E, the fifth inflation pattern X5 inflates the airbags 20c to 20f in the two rows of the middle row and the row above the middle row of the seat back 3. As shown in FIG. 4F, the sixth inflation pattern X6 inflates the airbags 20a to 20d in the two upper rows of the seat back 3. The controller 45 also performs an all-deflation pattern Z, which is shown in FIG. 4G, between the sequential inflation patterns X, while switching between the inflation patterns X (X1 to X6).

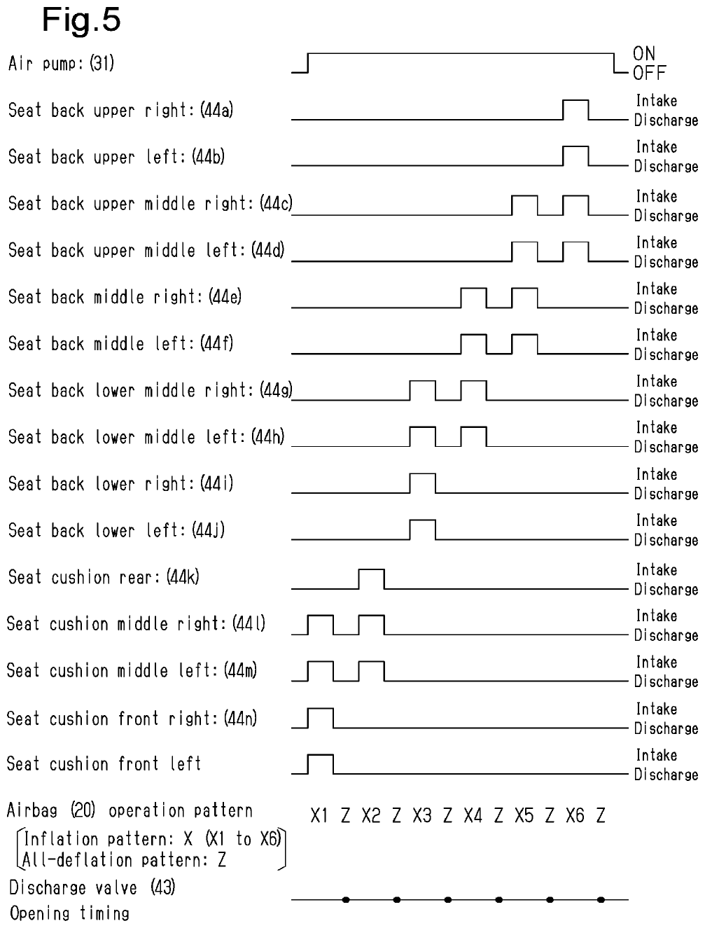

As shown in FIG. 5, in one example of the massage control, the controller 45 first performs the first inflation pattern X1 by bringing the intake-discharge valves 44l to 44o, which are located upstream of the airbags 20l to 20o in the two front rows of the seat cushion, into the inlet state (the first operation state) for a predetermined time period. Then, to perform the all-deflation pattern Z, the controller 45 brings the intake-discharge valves 44a to 44o, which correspond to the massage airbags 20a to 20o, into the discharge state for a predetermined time period. When performing the subsequent second inflation pattern X2 and the following inflation patterns X (X3 to X6), the controller 45 also performs the all-deflation pattern Z before a transition to the next inflation pattern X.

In addition, at the time point when the all-deflation pattern Z is performed, that is, in a state in which the massage airbags 20 are deflated, the controller 45 opens the discharge valve 43 in the first flow passage L1, which communicates with the seat-support airbags 10 (FIG. 3). Opening the discharge valve 43 decompresses the second flow passage L2, which communicates with the massage airbags 20. This reduces the load on the air pump 31, which remains driven while the massage control is performed.

That is, keeping the air pump 31 driven while the massage airbags 20 are inflated and deflated limits changes in the operation sound, which would otherwise occur when the air pump 31 is switched between ON and OFF. However, when the air pump 31 remains driven without feeding air into the airbags 20, the inner pressure of the second flow passage L2, which communicates with the airbags 20, increases. Specifically, the inner pressure increases on the upstream side of the intake-discharge valves 44 corresponding to the airbags 20. This intensifies the load on the air pump 31, increasing the operation sound, or the whine, of the air pump 31.

As shown in FIG. 3, as viewed from the second massage flow passage L2, the first seat-support passage L1 branches off from the second flow passage L2. In addition, during the massage control, the intake valves 42, which are in the first flow passage L1 and correspond to the seat-support airbags 10, are all closed. As such, an increase in the inner pressure of the second flow passage L2 increases the inner pressure of the first flow passage L1.

For this reason, the controller 45 opens the discharge valve 43 in the first flow passage L1, which is located upstream of the intake-discharge valves 44 corresponding to the massage airbags 20. That is, opening the discharge valve 43 achieves decompression of the second flow passage L2, as well as of the first flow passage L1. Further, the discharge valve 43 is opened at the time point when the all-deflation pattern Z, which deflates all the massage airbags 20, is performed. Accordingly, the decompression of the second flow passage L2 caused by the opening of the discharge valve 43 has a limited influence on opening of airbags 20. The seat device 30 is thus capable of reducing the load on the air pump 31 and improving the quietness, while ensuring the massage effect achieved by inflation-deflation of the airbags.

The present embodiment has the following advantages.

(1) The controller 45, which serves as a pressure-feeding control portion 60a, drives the air pump 31 to pressure-feed air to the massage airbags 20 located in the seat 1. In addition, the controller 45, which serves as an inflation-deflation control portion 60b, performs the massage control that inflates and deflates the airbags 20 while keeping the air pump 31 driven by controlling the operation of the intake-discharge valves 44 in the second flow passage L2 (the branch lines L2′), which connects the air pump 31 to the airbags 20. Furthermore, the controller 45, which serves as a decompression control portion 60c, opens the discharge valve 43, which is located upstream of the intake-discharge valves 44, in a state in which the airbags 20 are deflated during the massage control.

That is, the controller 45 keeps the air pump 31 driven while the massage airbags 20 are inflated and deflated. This limits changes in the operation sound of the air pump 31, which would otherwise occur when the air pump 31 is switched between ON and OFF. In addition, the discharge valve 43, which is on the upstream side of the intake-discharge valves, is opened to decompress the second flow passage L2. This reduces the load on the air pump 31, which remains driven while the massage control is performed. Accordingly, the operation sound of the air pump 31 is less likely to increase. Further, the discharge valve 43 is opened in a state in which the airbags 20 are deflated. Accordingly, the decompression of the second flow passage L2 caused by the opening of the discharge valve 43 has a limited influence on opening of airbags 20. This improves the quietness while ensuring the massage effect achieved by inflation-deflation of the airbags. In addition, the load on the air pump 31 is reduced, extending the useful life of the air pump 31.

(2) During the massage control, the controller 45 alternately performs an inflation pattern X, which inflates at least one of the massage airbags 20 located in the seat 1, and the all-deflation pattern Z, which deflates all of the airbags 20. The controller 45 opens the discharge valve 43 at the time point when the all-deflation pattern Z is performed. This further reduces, when airbags 20 are opened, the influence of the decompression of the second flow passage L2 caused by the opening of the discharge valve 43.

(3) The seat device 30 includes the seat-support airbags 10, which are independent of the massage airbags 20. The seat device 30 also includes the second massage flow passage L2, which connects the air pump 31 to the massage airbags 20. In addition, the seat device 30 includes the first seat-support passage L1, which branches off from the second flow passage L2 at a position upstream of the intake-discharge valves 44 corresponding to the massage airbags 20. The first flow passage L1 communicates with the seat-support airbags 10. When performing the massage control, the controller 45 decompresses the second flow passage L2 by opening the discharge valve 43 in the first flow passage L1.

This configuration achieves the decompression of the second flow passage L2 without requiring additional components, thereby limiting any increase in the manufacturing cost.

The above-described embodiment may be modified as follows.

The number and the position of the airbags 10 and 20 inside the seat 1 may be modified freely. In addition, the configuration of the flow passage L connecting the air pump 31 to the airbags 10 and 20 and the configuration of the intake-discharge device 50, such as the number and the position of the valve systems 40 in the flow passage L, may be modified freely.

During the massage control, the above-described embodiment alternately performs an inflation pattern X, which inflates at least one of the massage airbags 20, and the all-deflation pattern Z, which deflates all of the airbags 20. However, the massage control is not limited to this configuration. For example, the massage control does not have to include the all-deflation pattern Z, or may be performed with an operation pattern that keeps some of the airbags 20 inflated while deflating the other airbags 20.

The above-described embodiment opens the discharge valve 43 at the time point when the all-deflation pattern Z is performed to deflate all the airbags 20. However, the present invention is not limited to this configuration. For example, when the operation pattern that keeps some of the airbags 20 inflated while deflating the other airbags 20 is used, the discharge valve 43 may be opened in a state in which the relevant airbags 20 are deflated. The opening timing of the discharge valve 43 may be modified freely as long as the discharge valve 43 is opened in a state in which any one of the airbags 20 is deflated.

The inner pressure of the second flow passage L2 may be adjusted while being detected. For example, in the seat device 30 of the above embodiment, the inner pressure Px of the second massage flow passage L2 is equal to that of the first seat-support passage L1 during the massage control. As such, the inner pressure Px of the second flow passage L2 is detectable based on the output signal of the pressure sensor 51 in the first flow passage L1. The inner pressure Px may be adjusted to a pressure between a first pressure P1 that allows inlet of air into the massage airbags 20 and a second pressure P2 at which the pressure-feeding load on the air pump 31 is excessive. This reduces the load on the air pump 31 and improves the quietness, while ensuring the massage effect achieved by inflation-deflation of the airbags 20.

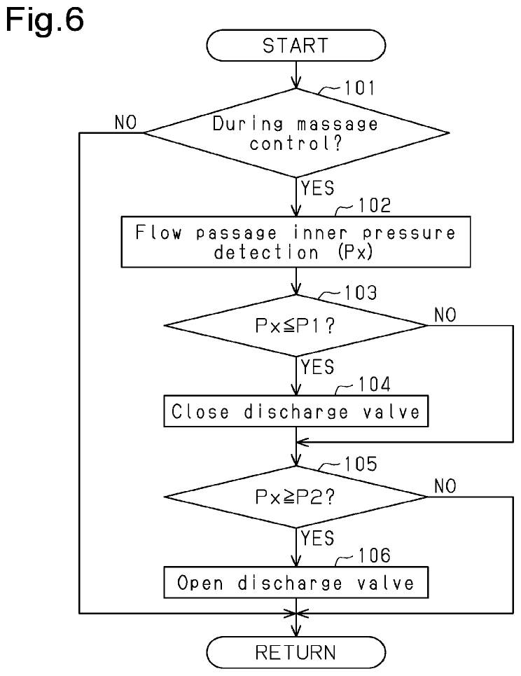

For example, as shown in the flowchart of FIG. 6, while the massage control is performed (step 101: YES), the controller 45 detects the inner pressure Px of the second flow passage L2 (step 102). When the inner pressure Px of the second flow passage L2 is less than or equal to the first pressure P1 (Px≤P1, step 103: YES), the controller 45 closes the discharge valve 43 in the first flow passage L1 (step 104). When the inner pressure Px of the second flow passage L2 is greater than or equal to the second pressure P2 (Px≥P2, step 105: YES), the controller 45 opens the discharge valve 43 (step 106).

At step 103, if the inner pressure Px of the second flow passage L2 is greater than the first pressure P1 (Px>P1, step 103: NO), the controller 45 does not perform the process of step 104. At step 105, if the inner pressure Px of the second flow passage L2 is less than the second pressure P2 (Px<P2, step 105: NO), the controller 45 does not perform the process of step 106. At step 106, the time period for which the discharge valve 43 is opened may be modified according to the discharge capability of the discharge valve 43.

The controller 45 of the above embodiment serves as the pressure-feeding control portion 60a, the inflation-deflation control portion 60b, and the decompression control portion 60c. However, the present invention is not limited to this configuration, and these functional control portions may be separate information processors.

1. A vehicle seat device comprising:
an air pump;
a pressure-feeding control portion configured to pressure-feed air to an airbag located in a seat by driving the air pump;
an intake-discharge valve located in a flow passage connecting the air pump to the airbag;
an inflation-deflation control portion configured to inflate and deflate the airbag by controlling operation of the intake-discharge valve while keeping the air pump driven;
a discharge valve located upstream of the intake-discharge valve in the flow passage; and
a decompression control portion configured to open the discharge valve in a state in which the airbag is deflated.

2. The vehicle seat device according to claim 1, wherein
the airbag is one of a plurality of airbags located in the seat,
the inflation-deflation control portion is configured to alternately perform an inflation pattern, which inflates at least one of the airbags, and an all-deflation pattern, which deflates all of the airbags, and
the decompression control portion is configured to open the discharge valve at a time point when the all-deflation pattern is performed.

3. The vehicle seat device according to claim 1, further comprising:
a massage airbag that is configured to be inflated and deflated based on operation of the intake-discharge valve;
a seat-support airbag that is independent of the massage airbag;
a massage flow passage that connects the air pump to the massage airbag; and
a seat-support flow passage that branches off from the massage flow passage at a position upstream of the intake-discharge valve and communicates with the seat-support airbag,
wherein the decompression control portion is configured to open the discharge valve located in the seat-support flow passage.

4. A method for controlling air pressure of a vehicle seat, the method comprising:
pressure-feeding air to an airbag located in a seat by driving an air pump;
inflating and deflating the airbag while keeping the air pump driven by controlling operation of an intake-discharge valve located in a flow passage connecting the air pump to the airbag; and
opening a discharge valve located upstream of the intake-discharge valve in the flow passage in a state in which the airbag is deflated.

5. The method for controlling air pressure of a vehicle seat according to claim 4, wherein
the airbag is one of a plurality of airbags located in the seat,
inflating and deflating the airbag includes alternately performing an inflation pattern, which inflates at least one of the airbags, and an all-deflation pattern, which deflates all of the airbags, and
the discharge valve is opened at a time point when the all-deflation pattern is performed.

6. The method for controlling air pressure of a vehicle seat according to claim 4, the method further comprising:
opening and closing the discharge valve located upstream of the intake-discharge valve in the flow passage to adjust inner pressure of a section of the flow passage that is upstream of the intake-discharge valve to a pressure between a first pressure that allows inlet of air into the airbag and a second pressure at which pressure-feeding load on the air pump is excessive.
